(19) United States
(12) Patent Application Publication
(10) Pub. No.: US 2023/0189968 A1
(43) Pub. Date: Jun. 22, 2023

(54) CARRIER STRAP ASSEMBLY FOR USE IN ASSOCIATION WITH AN INFANT SAFETY SEAT

(71) Applicants: Patrick Brechting, Grand Rapids, MI (US); Kevin Brechting, Ada, MI (US)

(72) Inventors: Patrick Brechting, Grand Rapids, MI (US); Kevin Brechting, Ada, MI (US)

(21) Appl. No.: 17/559,334

(22) Filed: Dec. 22, 2021

(51) Int. Cl. A45F 3/14; B60N 2/28

(52) U.S. Cl. CPC A45F 3/14; B60N 2/2845; A45F 2003/142; A45F 2003/144

(57) ABSTRACT

A carrier strap assembly, including: (a) a strap member; (b) a shoulder pad; (c) a length adjustment member; (d) an elastic storage loop; and (e) wherein the carrier strap member enables a user to carry his/her infant in a safety seat in a simple and ergonomic manner.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to infant safety seats (e.g., carriers, car seats, etcetera), and, more particularly, to carrier strap assemblies that enable a user to carry his/her infant in a safety seat in a simple and ergonomic manner.

### 2. Background Art

Infant safety seats have been known in the art for years and are the subject of several patents and publications, including: U.S. Pat. No. 9,487,110 entitled “Car Seat,” U.S. Pat. No. 7,325,871 entitled “Infant Car Seat,” U.S. Pat. No. 7,472,955 entitled “Infant Car Seat,” U.S. Pat. No. 7,004,541 entitled “Adjustable Infant Car Seat with Multiple-Range Angle Indicator,” U.S. Pat. No. 6,986,518 entitled “Combined Baby Car Seat and Stroller,” U.S. Pat. No. 6,561,577 entitled “Infant Seat with Adjustable Handle,” U.S. Pat. No. 6,428,100 entitled “Juvenile Transportation System,” U.S. Pat. No. 5,567,008 entitled “Portable Infant Seat Having a Detachable Base,” U.S. Pat. No. 5,324,094 entitled “Handle for Infant Car Seat,” and U.S. Pat. No. 4,902,026 entitled “Convertible Car Seat Apparatus” - all of which are hereby incorporated herein by reference in their entirety including all references cited therein.

U.S. Pat. No. 9,487,110 appears to disclose embodiments of a car seat that include an outer protective shell, an inner seat, a suspension system connecting and permitting relative movement between the inner seat and the outer protective shell for shock isolation, and a harness adapted to hold an occupant to the inner seat and not attached to the outer protective shell. In an accident, regardless of the direction in which the seat is facing and regardless of whether the result is a sudden acceleration and/or deceleration, the inner seat will move inside the frame, and the suspension system will absorb some, much, or all of the energy. Energy not absorbed by the suspension system may be absorbed by the inner seat itself and/or an anchor system used to connect the car seat to a vehicle. The frame of the seat will remain structurally intact in almost all circumstances thereby protecting the occupant of the car seat.

U.S. Pat. No. 7,325,871 appears to disclose an infant car seat that includes a base including a belt path along which a vehicle belt can be secured to the base, and a carrier to detachably couple to the base. The carrier is positionable in a first, reclined position and a second, upright position. The belt path is fixed in location on the base such that the carrier can be positioned in either the first, reclined position or the second, upright position without adjustment of the vehicle belt relative to the base. This two-position infant carrier provides improved fit to the child. The infant car seat also can include grips on the carrier of the infant car seat for improved carryability, grips on the base of the infant car seat for improved gripping of the vehicle seat and easier installation, and an adjustable height mechanism in the base for improved fit to vehicle seat.

U.S. Pat. No. 7,472,955 appears to disclose an infant car seat that includes a base and a carrier to detachably secure to the base. In an exemplary infant car seat, the carrier can have a carrier weight of less than 10 pounds, and the infant car seat can have a rated weight of up to 40 pounds. In another exemplary infant car seat, the carrier can have a carrier weight of less than 10 pounds, a front surface of the seat back of the carrier can have a length greater than about 20 inches, and the infant car seat can have a rated weight of at least about 27.5 pounds. In another exemplary infant car seat, the carrier can have a carrier weight of less than 10 pounds, a front surface of the seat back of the carrier can have a length greater than about 20 inches, and the infant car seat can have a rated weight of greater than 22 pounds. In another exemplary infant car seat, the carrier can have a carrier weight of less than 10 pounds, and the infant car seat can have a rated height of up to 35 inches. In another exemplary infant car seat, the carrier can have a carrier weight of less than 10 pounds and can provide legroom of greater than 2 inches in an upright latching position.

U.S. Pat. No. 7,004,541 appears to disclose an improved infant car seat that includes a seat shell and a pendulum having a multiple-range angle indicator pivotably suspended within the seat shell to allow proper angular orientation of the seat shell. The indicator may comprise a color that contrasts with the color of the surrounding face of the pendulum. The indicator is visible through a first viewing area in the seat shell when an angular orientation of the seat shell is within a first range and is visible through a second viewing area in the seat shell when an angular orientation of the seat shell is within a second range. The indicator may comprise additional viewing areas that correspond with additional ranges of angular orientation.

U.S. Pat. No. 6,986,518 appears to disclose a combined baby car seat and stroller that includes a base member removably attachable to the seat of an automobile and a seat member removably engageable and lockable with the base member. The seat member includes a hide-away canopy connected thereto and a plurality of wheels connected to the bottom portion thereof for allowing the seat member to be rolled on a surface. The device further includes an elongated carry handle connected to select ones of the plurality of wheels and a telescopic member connected to the seat member and extendable outwardly and away therefrom for aiding an operator in advancing the seat member when removed from the base member. The device further includes a foot lever and a rocker member positioned below the plurality of wheels so that the seat member can be oscillated along an arcuate path. The seat member may be reclined for convenient travel sleeping.

U.S. Pat. No. 6,561,577 appears to disclose an infant seat that includes a shell, a handle, and a spring. The handle has an arm hub coaxially aligned with, and rotatably attached to, a side hub of the shell. In one design, the side hub has notches, and the arm hub a projection. A spring has a longitudinal axis aligned substantially parallel to the hub axis and is positioned to radially bias the projection into engagement with a rotationally-aligned notch. The handle is movable in a direction substantially perpendicular to the hub axis to disengage the projection from the radially-aligned notch permitting the handle to be rotated to other notches corresponding to other handle positions. In another design, the arm hub has the notches, and the side hub has the projection.

U.S. Pat. No. 6,428,100 appears to disclose a juvenile transportation system which includes a seat shell detachably mountable on a small base wherein the small base is formed to be mounted on a vehicle seat with a seat belt. The small base is adapted to be mounted on a rear portion of a vehicle seat such that a portion of the seat shell lies on a forward portion of the vehicle seat when the seat shell is coupled with the small base. A large base can also be provided, the seat shell being adapted to be mounted on either the small base or the large base.

U.S. Pat. No. 5,567,008 appears to disclose a restraining system for a child. The restraining system includes a base mountable to a car seat and an infant carrier including a shell received by the base. A clamp arm engages the shell and couples the shell to the base. The clamp arm is movable to a release position disengaged from the shell. The restraining system further includes a release button mounted to the shell for movement to an activated position engaging and moving the clamp arm to the release position.

U.S. Pat. No. 5,324,094 appears to disclose an infant carrier that comprises a seat having a front, back, opposed parallel side walls, and a handle having opposed parallel legs with one end of each of the legs being pivotally connected to a mating side wall. The legs extend upwardly and inwardly from the side walls and terminate at their distal ends in a spaced apart relationship along a longitudinal axis between the side walls. A handgrip connects the distal ends of the legs so that the axis of the handgrip extends along the longitudinal axis between the side walls.

U.S. Pat. No. 4,902,026 appears to disclose a convertible car seat apparatus which is set forth wherein an “L” shaped car seat is provided with a pivotally mounted “U” shaped frame mounted to the sides of the car seat wherein the frame, when positioned in a first downward position, retracts the associated wheels of the car seat underlying the seat wherein pivoting of the “U” shaped frame to a position overlying the seat in a second position extends the wheels of the car seat and further enables extension of a sunshade positioned within the “U” shaped frame, as well as the removal of a padded abutment member positioned between the shade and the seat. Further, storage pouches are secured to the sides and rear surface of the seat for storage of articles associated with the care of an associated infant within the seat.

While the above-identified patents and publications do appear to disclose various infant safety seats, their configurations remain non-desirous and/or problematic inasmuch as, among other things, none of the above-identified infant safety seats appear to be associated with a carrier strap assembly that enables a user to carry his/her infant in a safety seat in a simple and ergonomic manner.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a carrier strap assembly, comprising, consisting essentially of and/or consisting of: (a) a strap member; (b) a shoulder pad; (c) a length adjustment member; (d) an elastic storage loop; and (e) wherein the carrier strap member enables a user to carry his/her infant in a safety seat in a simple and ergonomic manner.

In a preferred embodiment of the present invention, the strap member comprises a primary loop and a secondary loop.

In another preferred embodiment of the present invention, the primary loop of the strap member is adjustable and the secondary loop of the strap member is non-adjustable. In this embodiment, the secondary loop of the strap member preferably emanates contiguously from the primary loop of the strap member.

In yet another preferred embodiment of the present invention, the primary loop and the secondary loop of the strap member are separated from each other via a double layered stitching section.

In one preferred aspect of the present invention, the shoulder pad is associated with the primary adjustable loop.

In a preferred embodiment of the present invention, the length adjustment member comprises a slide buckle. In this embodiment, the slide buckle is preferably associated with the primary adjustable loop.

In another preferred embodiment of the present invention, the elastic storage loop is positioned external to the primary adjustable loop. In this embodiment, the elastic storage loop is preferably secured to a first end of the strap member.

In yet another preferred embodiment of the present invention, the strap member is fabricated from natural fibers, synthetic fibers, cotton, wool, rayon, nylon, polypropylene, polyurethane, polyester, saran, spandex, vinalon, nomex, kevlar, twaron, lyocell, zylon, and/or vectran.

The present invention is also directed to a carrier strap assembly, comprising, consisting essentially of and/or consisting of: (a) a strap member, wherein the strap member is fabricated from polypropylene and comprises a primary loop and a secondary loop, wherein the primary loop of the strap member is adjustable, and the secondary loop of the strap member is non-adjustable, and wherein the secondary loop of the strap member emanates contiguously from the primary loop of the strap member; (b) a shoulder pad, wherein the shoulder pad is associated with the primary adjustable loop; (c) a length adjustment member, wherein the length adjustment member comprises a slide buckle, and wherein the slide buckle is associated with the primary adjustable loop; (d) an elastic storage loop, wherein the elastic storage loop is positioned external to the primary adjustable loop and wherein the elastic storage loop is secured to a first end of the strap member; and (e) wherein the carrier strap member enables a user to carry his/her infant in a safety seat in a simple and ergonomic manner.

The present invention is further directed to a carrier strap assembly in combination with an infant safety seat, comprising, consisting essentially of and/or consisting of: (a) a carrier strap assembly comprising: (1) a strap member having a primary loop and a secondary loop; (2) a shoulder pad; (3) a length adjustment member; and (4) an elastic storage loop; and (b) an infant safety seat comprising: (1) a body, wherein the body is adapted to contain an infant; (2) a handle; and (3) wherein the carrier strap assembly is releasably secured to the handle of the infant safety seat via a slip knot formed using the primary and secondary loops of the strap member.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a side view of a first embodiment of a carrier strap assembly manufactured in accordance with the present invention;

FIG. 2 of the drawings is a top view of the carrier strap assembly of FIG. 1 ;

FIG. 3 of the drawings is a bottom view of the carrier strap assembly of FIG. 1 ;

FIG. 4 of the drawings is a perspective view of a first embodiment of the carrier strap assembly manufactured in accordance with the present invention, showing a user wearing the carrier strap assembly attached to an infant safety seat;

FIG. 5 of the drawings is a side view of a first embodiment of the carrier strap assembly manufactured in accordance with the present invention, showing a user wearing the carrier strap assembly attached to an infant safety seat; and

FIG. 6 of the drawings is a side view of a first embodiment of a carrier strap assembly manufactured in accordance with the present invention, shown in a storage configuration using the elastic storage loop.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

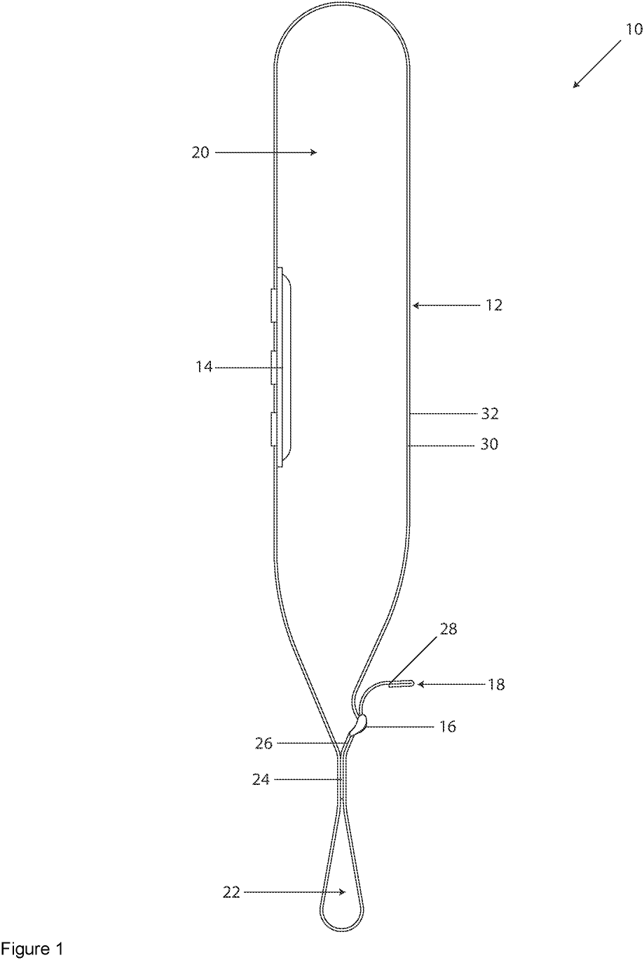

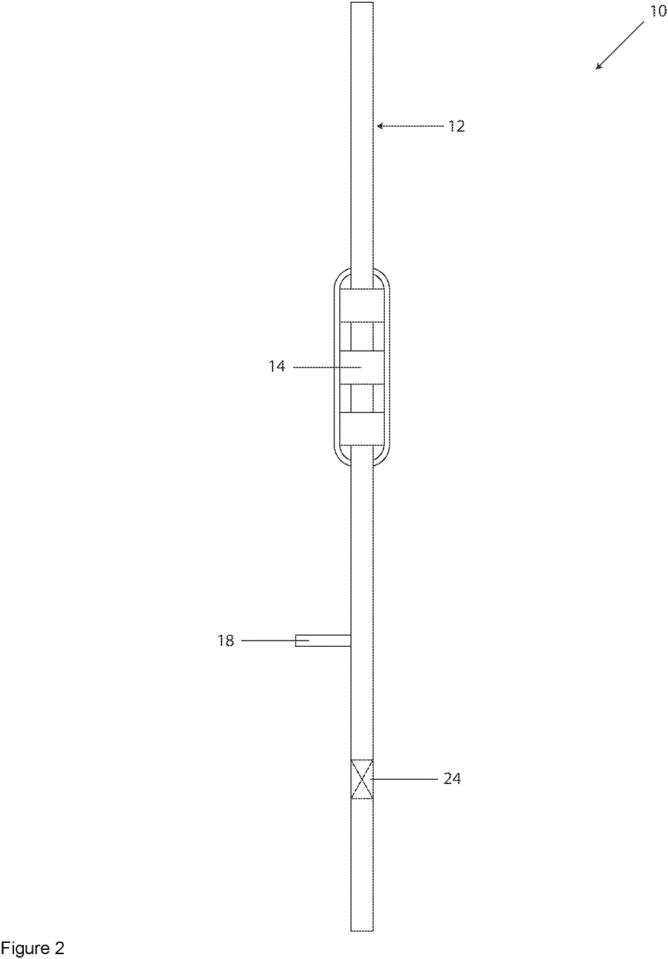

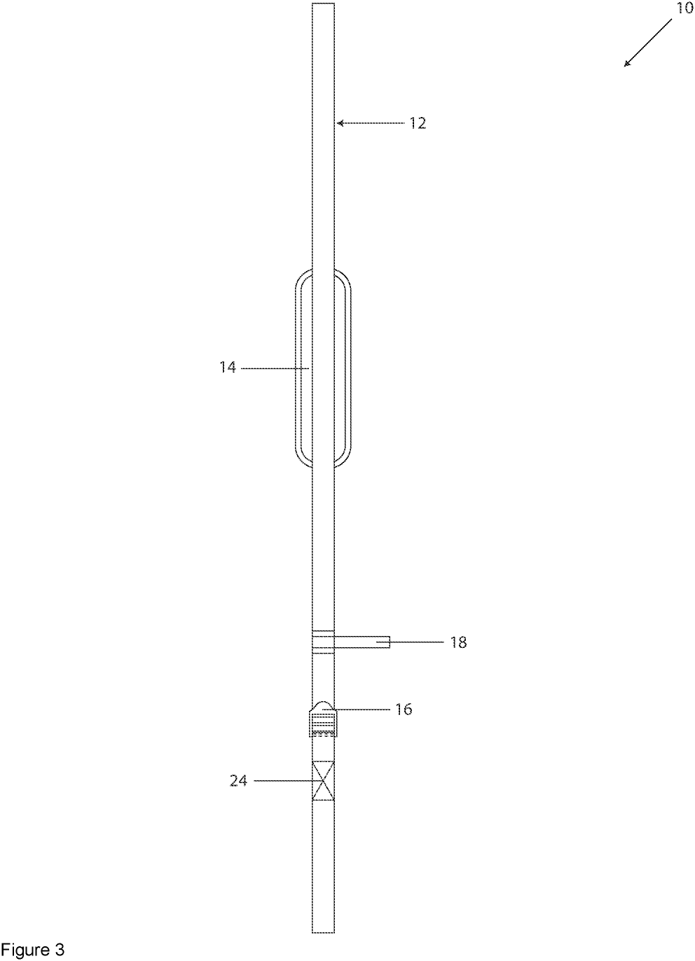

Referring now to the drawings, and to FIGS. 1-3 in particular, a first embodiment of carrier strap or harness assembly 10 is shown as generally comprising strap member 12, shoulder pad 14, length adjustment member 16 (e.g., slide buckle), elastic storage loop 18.

In accordance with the present invention, carrier strap assembly 10 enables a user to carry his/her infant in a safety seat in a simple and ergonomic manner.

In a preferred embodiment of the present invention, the strap member comprises primary closed loop 20 and a secondary closed loop 22. Primary loop 20 of strap member 12 is adjustable (using length adjustment member 16) and secondary loop 22 of strap member 12 is non-adjustable. As is best shown in FIG. 1, secondary loop 22 of the strap member preferably emanates contiguously from primary loop 20 of the strap member. As is best shown in FIGS. 1-3, primary loop 20 and secondary loop 22 of strap member 12 are separated from each other via double layered stitching section 24.

Strap member 12 is preferably fabricated from natural fibers, synthetic fibers, cotton, wool, rayon, nylon, polypropylene, polyurethane, polyester, saran, spandex, vinalon, nomex, kevlar, twaron, lyocell, zylon, and/or vectran.

Shoulder pad 14 is associated with primary adjustable loop 20. It will be understood that shoulder pad 14 may be woven, stitched, glued, or secured to loop 20 using any one of a number of conventional techniques.

Carrier strap assembly 10 also includes length adjustment member 16. In one embodiment, the length adjustment member comprises a buckle, such as a slide buckle. In this embodiment, the slide buckle is preferably associated with primary adjustable loop 20.

In accordance with the present invention, carrier strap assembly 10 further optionally includes elastic storage loop 18 which is positioned external to primary adjustable loop 20. In this embodiment, elastic storage loop 18 is preferably secured to first end 26 of strap member 12. Strap member 12 also includes second end 28, inner surface 30, and outer surface 32. Strap member 12 is preferably fabricated from a single piece of material that is approximately five to ten feet long and formed via stitching where appropriate.

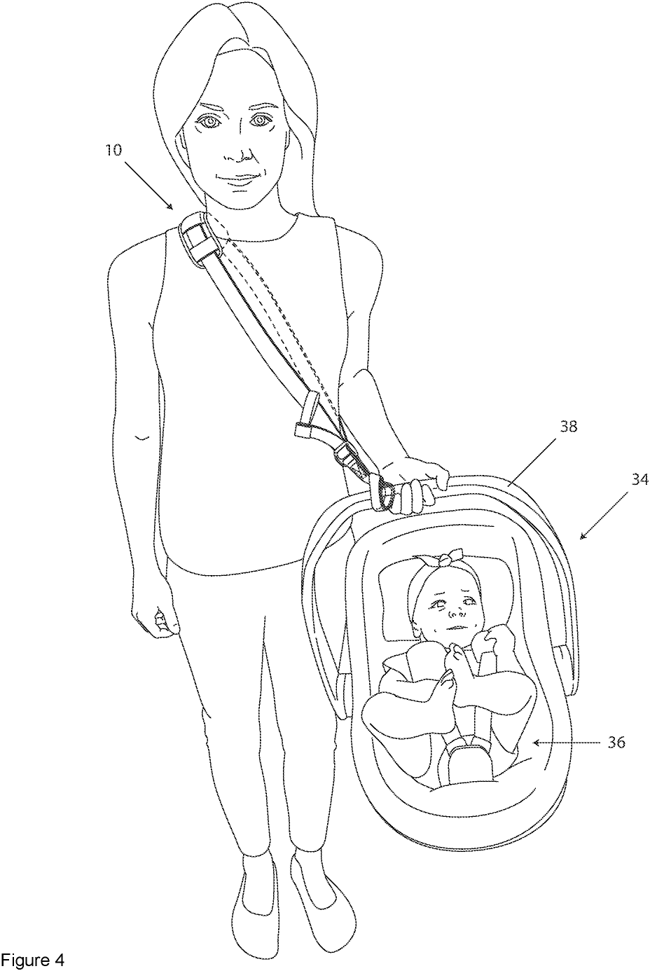

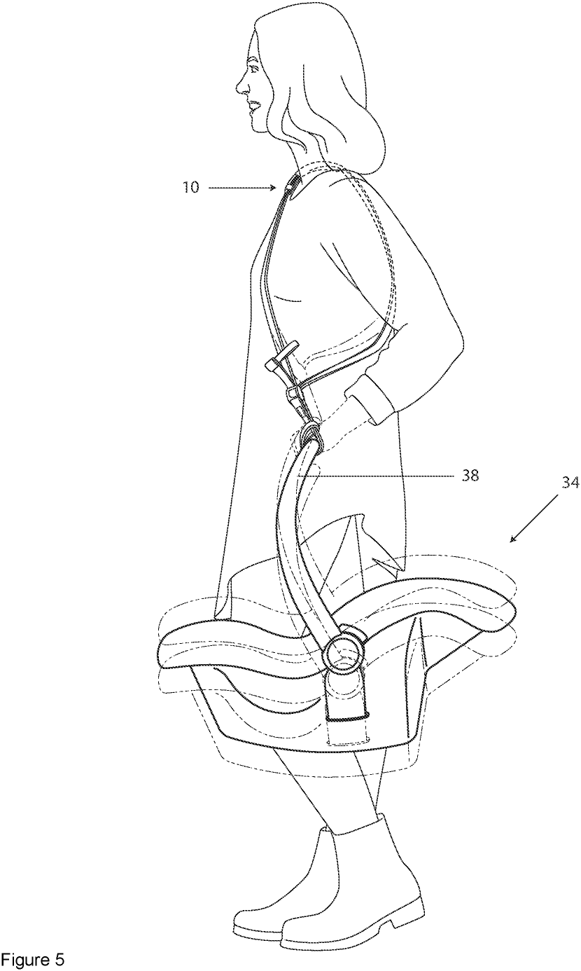

Referring now to FIGS. 4-5, the present invention is further directed to a carrier strap assembly in combination with an infant safety seat, comprising: carrier strap assembly 10 comprising: a strap member having a primary loop and a secondary loop; a shoulder pad; a length adjustment member; and an optional elastic storage loop; and infant safety seat 34 comprising: body 36, wherein the body is adapted to contain an infant; and handle 38. Carrier strap assembly 10 is releasably secured to handle 38 of the infant safety seat via a knot (e.g., slip-type) formed using the primary and secondary loops of the strap member. In particular, the secondary loop is positioned under the handle and the primary loop is inserted through the secondary loop until the strap assembly is taught against the handle of the safety seat.

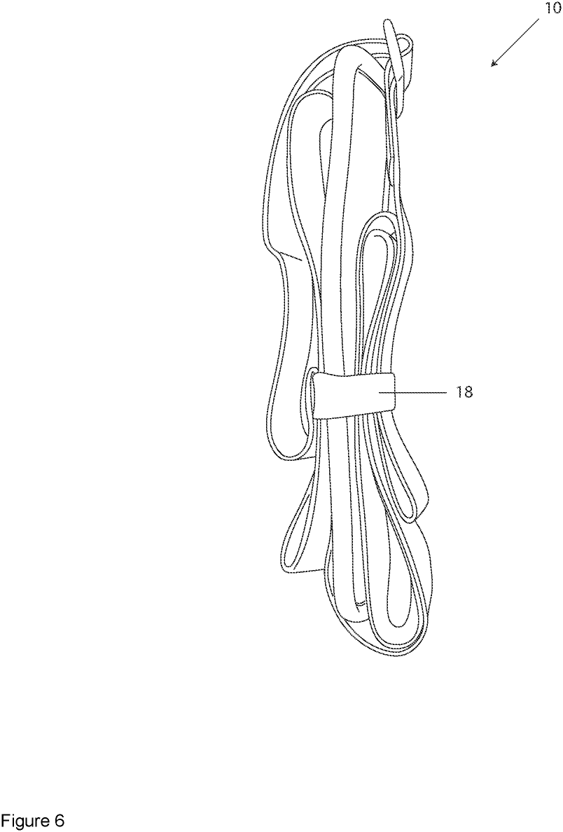

As is shown in FIG. 6, elastic storage loop 18 can be used to keep carrier strap assembly 10 organized during storage and/or non-use.

The carrier strap assembly of the present invention allows a user to distribute the weight of the infant and safety seat over a broad area, thus relieving strain to the musculoskeletal system of the user.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A carrier strap assembly, comprising:
a strap member, wherein the strap member comprises a primary loop and a secondary loop, and wherein the secondary loop is stitched closed and unopenable;
a shoulder pad;
a length adjustment member;
an elastic storage loop; and
wherein the carrier strap assembly enables a user to carry his/her infant in a safety seat in a simple and ergonomic manner.

2. (canceled)

3. The carrier strap assembly according to claim 1, wherein the primary loop of the strap member is adjustable.

4. The carrier strap assembly according to claim 1, wherein the secondary loop of the strap member is non-adjustable.

5. The carrier strap assembly according to claim 1, wherein the secondary loop of the strap member emanates contiguously from the primary loop of the strap member.

6. The carrier strap assembly according to claim 1, wherein the primary loop and the secondary loop of the strap member are separated from each other via a double layered stitching section.

7. The carrier strap assembly according to claim 1, wherein the shoulder pad is associated with the primary adjustable loop.

8. The carrier strap assembly according to claim 1, wherein the length adjustment member comprises a slide buckle.

9. The carrier strap assembly according to claim 8, wherein the slide buckle is associated with the primary adjustable loop.

10. The carrier strap assembly according to claim 1, wherein the elastic storage loop is positioned external to the primary adjustable loop.

11. The carrier strap assembly according to claim 1, wherein the elastic storage loop is secured to a first end of the strap member.

12. The carrier strap assembly according to claim 1, wherein the strap member is fabricated from natural fibers, synthetic fibers, cotton, wool, rayon, nylon, polypropylene, polyurethane, polyester, saran, spandex, vinalon, nomex, kevlar, twaron, lyocell, zylon, and/or vectran.

13. A carrier strap assembly, consisting of:
a strap member, wherein the strap member is fabricated from polypropylene and includes a primary loop and a secondary loop, wherein the primary loop of the strap member is adjustable, and the secondary loop of the strap member is stitched closed, unopenable, and non-adjustable, and wherein the secondary loop of the strap member emanates contiguously from the primary loop of the strap member;
a shoulder pad, wherein the shoulder pad is associated with the primary adjustable loop;
a length adjustment member, wherein the length adjustment member includes a slide buckle, and wherein the slide buckle is associated with the primary adjustable loop;
an elastic storage loop, wherein the elastic storage loop is positioned external to the primary adjustable loop and wherein the elastic storage loop is secured to a first end of the strap member; and
wherein the carrier strap assembly enables a user to carry his/her infant in a safety seat in a simple and ergonomic manner.

14. A carrier strap assembly in combination with an infant safety seat, comprising:
the carrier strap assembly comprising:
a strap member having a primary loop and a secondary loop, wherein the secondary loop is stitched closed and unopenable;
a shoulder pad;
a length adjustment member; and
an elastic storage loop; and
the infant safety seat comprising:
a body, wherein the body is adapted to contain an infant;
a handle; and
wherein the carrier strap assembly is releasably secured to the handle of the infant safety seat via a slip knot formed using the primary and secondary loops of the strap member.
